(19) United States
(12) Patent Application Publication
(10) Pub. No.: US 2006/0230722 A1
(43) Pub. Date: Oct. 19, 2006

(54) Multi-cyclone apparatus for vacuum cleaner

(75) Inventors: Jang-keun Oh, Gwangju-city (KR); Hak-bong Lee, Jellanam-do (KR)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/317,455

(22) Filed: Dec. 23, 2005

Related U.S. Application Data
(60) Provisional application No. 60/666,053, filed on Mar. 29, 2005.

(30) Foreign Application Priority Data
May 13, 2005 (KR) 10-2005-0040190

(51) Int. Cl. B01D 45/12

(52) U.S. Cl. 55/345

(57) ABSTRACT

Provided is a multi-cyclone apparatus for a vacuum cleaner with a high dust collection efficiency. The multi-cyclone apparatus has a primary cyclone separating a large-sized contaminant from air drawn in via an air inlet, a guide vane formed under the air inlet in the primary cyclone to increase a speed of air drawn into the primary cyclone, a primary contaminant receptacle collecting a contaminant separated by the primary cyclone, a plurality of secondary cyclones fluidly communicated with the primary cyclone to separate a fine contaminant from drawn-in air, and a secondary contaminant receptacle collecting the contaminant separated by the secondary cyclones.

### CROSS-REFERENCE TO RELATED APPLICATIONS

This application claims benefit under 35 U.S.C. § 119 of Korean Patent Application No. 2005-40190 filed on May 13, 2005, and U.S. Provisional application No. 60/666,053 filed on Mar. 29, 2005, the entire content of both of which are incorporated herein by reference.

### BACKGROUND OF THE INVENTION

1. Field of the Invention

The present invention relates to a multi-cyclone apparatus for a vacuum cleaner. More particularly, the present invention relates to a multi-cyclone apparatus in which the rotation force of drawn-in air improves.

2. Description of the Related Art

A conventional cyclone apparatus is generally configured to separate contaminant from air drawn in from a cleaning surface by a suction force of a motor assembly. The cyclone apparatus has a single structure comprising a cyclone forming a rotative stream to separate contaminant from drawn-in air, an air inlet allowing drawn-in air to flow in a tangential direction of the cyclone, and a contaminant receptacle collecting contaminant separated by the cyclone.

The dust collection efficiency of cyclone apparatus is proportional to the magnitude of centrifugal force operating on the rotative stream in the cyclone, and the centrifugal force is proportional to a rotative speed of air drawn in via the air inlet. Accordingly, it is required to increase the rotation speed of drawn-in air to enhance the dust collection efficiency. To increase the rotation speed of drawn-in air, a motor assembly should be employed which can generate greater suction force. However, if the motor assembly generating greater suction force is employed, the manufacturing cost increases.

To solve the above problem, the applicant has filed an application to increase the rotation speed of air by using a guide vane. The detail is disclosed in the Patent Application No. 10-2003-0067765 filed on Sep. 30, 2003, and therefore, the detailed description thereof will be omitted.

The cyclone apparatus with a single cyclone structure separates at once large-sized and fine contaminants from drawn-in air. Accordingly, if the rotation speed increases as can be seen in the already-filed application, relatively large-sized and heavy contaminants can be easily filtered so that the dust collection efficiency can increase to some degree. However, fine contaminants such as dusts re-ascend to discharge with air via a discharge opening so that the dust collection efficiency can not efficiently increase.

### SUMMARY OF THE INVENTION

The present invention has been conceived to solve the above-mentioned problems occurring in the prior art, and an aspect of the present invention is to provide a multi-cyclone apparatus for a vacuum cleaner that can efficiently increase a dust collection efficiency without requiring a high capacity of motor assembly.

According to an aspect of the present invention, there is provided a multi-cyclone apparatus for a vacuum cleaner, comprising, a primary cyclone separating a large-sized contaminant from air drawn in via an air inlet, a guide vane formed under the air inlet in the primary cyclone to increase a speed of air drawn into the primary cyclone, a primary contaminant receptacle collecting a contaminant separated by the primary cyclone, a plurality of secondary cyclones in fluid communication with the primary cyclone to separate a fine contaminant from drawn-in air, and a secondary contaminant receptacle collecting the contaminant separated by the secondary cyclones.

The guide vane comprises a plurality of inclined wings radially arranged by regular intervals, and a space between each of the plurality of inclined wings is opened.

According to another aspect of the present invention, there is provided a multi-cyclone apparatus for a vacuum cleaner comprising a primary cyclone separating a large-sized contaminant from air drawn in via an air inlet, a guide vane formed under the air inlet in the primary cyclone to increase a speed of air drawn into the primary cyclone, a primary contaminant receptacle formed under the primary cyclone to collect a contaminant separated by the primary cyclone, a plurality of second cyclones formed under the primary contaminant receptacle to separate a fine contaminant from air drawn in from the primary cyclone, and a secondary contaminant receptacle formed under the plurality of secondary cyclones to collect the contaminant separated by the secondary cyclones. Accordingly, the rotation force of air flowing into the multi-cyclone apparatus increases and the capacity of fine contaminant of the multi cyclone apparatus also increases.

The primary contaminant receptacle may comprise an air discharge pipe having opened opposite ends and upwardly protruding from a center of a bottom surface to fluidly communicate with a grille of the primary cyclone.

The apparatus may further comprise a primary cover disposed between the primary contaminant receptacle and the plurality of secondary cyclones, and having a plurality of centrifugal air paths in fluid communication with the air discharge pipe, a plurality of discharge openings in fluid communication with the plurality of secondary cyclones, and an air outlet discharging air flowed out of the plurality of discharge openings.

The primary cover further comprises an air inlet pipe of which a top end is connected with the air discharge pipe and of which a bottom end is connected with the plurality of centrifugal air paths radially arranged.

According to yet another aspect of the present invention, there is provided a multi-cyclone apparatus for a vacuum cleaner comprising a primary cyclone separating a large-sized contaminant from air drawn in via an air inlet, a guide vane formed under the air inlet in the primary cyclone to increase a speed of air drawn into the primary cyclone, a primary contaminant receptacle collecting a contaminant separated by the primary cyclone, a plurality of second cyclones formed around the primary cyclone to separate a fine contaminant from air drawn in from the primary cyclone, and a secondary contaminant receptacle formed around the primary contaminant receptacle to collect the contaminant separated by the plurality of secondary cyclones.

The guide vane may comprise a plurality of inclined wings radially arranged by regular intervals, and a space between each of the plurality of inclined wings may be opened.

The apparatus further comprises a secondary cover formed over the primary cyclone and the plurality of secondary cyclones and having the plurality of centrifugal air paths guiding air, discharged from the primary cyclone, to the plurality of secondary cyclones.

The apparatus further comprises a tertiary cover formed over the secondary cover and having an air outlet discharging air which passes the plurality of secondary cyclones.

The air inlet may be connected with an extension pipe extended to the outside of the secondary contaminant receptacles.

The primary contaminant receptacle and the secondary contaminant receptacle may be integrally formed.

As described above, according to the multi-cyclone apparatus for a vacuum cleaner consistent with the embodiments of the present invention, the rotation speed of air flowing into the primary cyclone increases so that the dust collection efficiency can be enhanced without requiring a high capacity of motor assembly.

The multi-cyclone apparatus for a vacuum cleaner consistent with the embodiments of the present invention has the primary cyclone and the plurality of secondary cyclones arranged in series so that the dust collection efficiency can be enhanced and fine contaminants such as dusts can be more efficiently collected. According to the multi-cyclone apparatus consistent with the first embodiment of the present invention, more fine contaminants can be collected in comparison with the conventional arts.

The multi-cyclone apparatus consistent with embodiments of the present invention can change the position of the air outlet according to the arrangement of the motor assembly, and therefore, the vacuum cleaner can be more freely design without great limitation.

Additionally, according to the multi-cyclone apparatus consistent with embodiments of the present invention, the motor assembly with a high capacity is not required to increase the dust collection efficiency so that the vacuum cleaner can be miniaturized and the manufacturing cost can decrease.

### BRIEF DESCRIPTION OF THE DRAWINGS

The above and other aspects, features and advantages of the present invention will be more apparent from the following detailed description taken with reference to the accompanying drawings, in which:

FIG. 1 is a cross-sectional view of a multi cyclone apparatus for a vacuum cleaner according to the first embodiment of the present invention;

FIG. 2 is an exploded perspective view of the multi-cyclone apparatus for a vacuum cleaner of FIG. 1 according to the first embodiment of the present invention;

FIG. 3 is a cross-sectional view of a multi-cyclone apparatus for a vacuum cleaner according to the second embodiment of the present invention; and

FIG. 4 is an exploded perspective view of the multi-cyclone apparatus for a vacuum cleaner of FIG. 3 according to the second embodiment of the present invention.

### DETAILED DESCRIPTION OF THE EXEMPLARY EMBODIMENTS

Exemplary embodiments of the present invention will be described in detail with reference to the annexed drawings. In the drawings, the same elements are denoted by the same reference numerals throughout the drawings. In the following description, detailed descriptions of known functions and configurations incorporated herein have been omitted for conciseness and clarity.

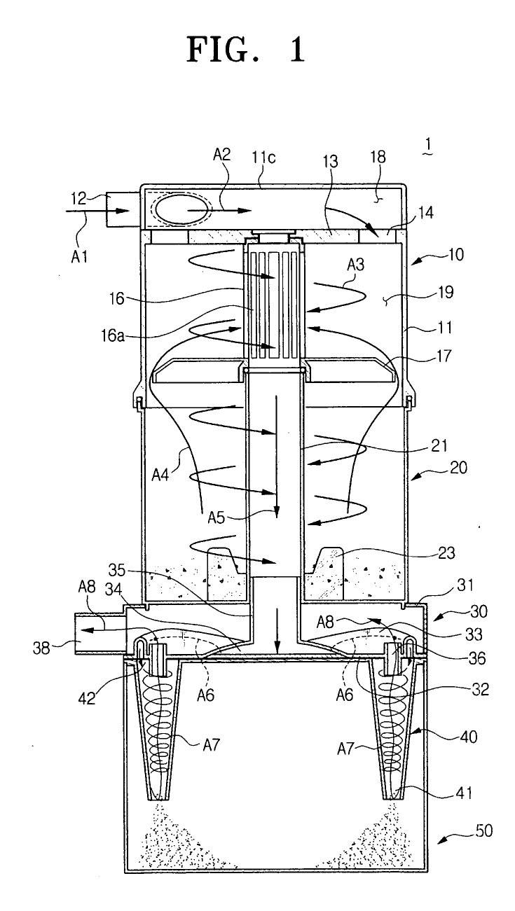

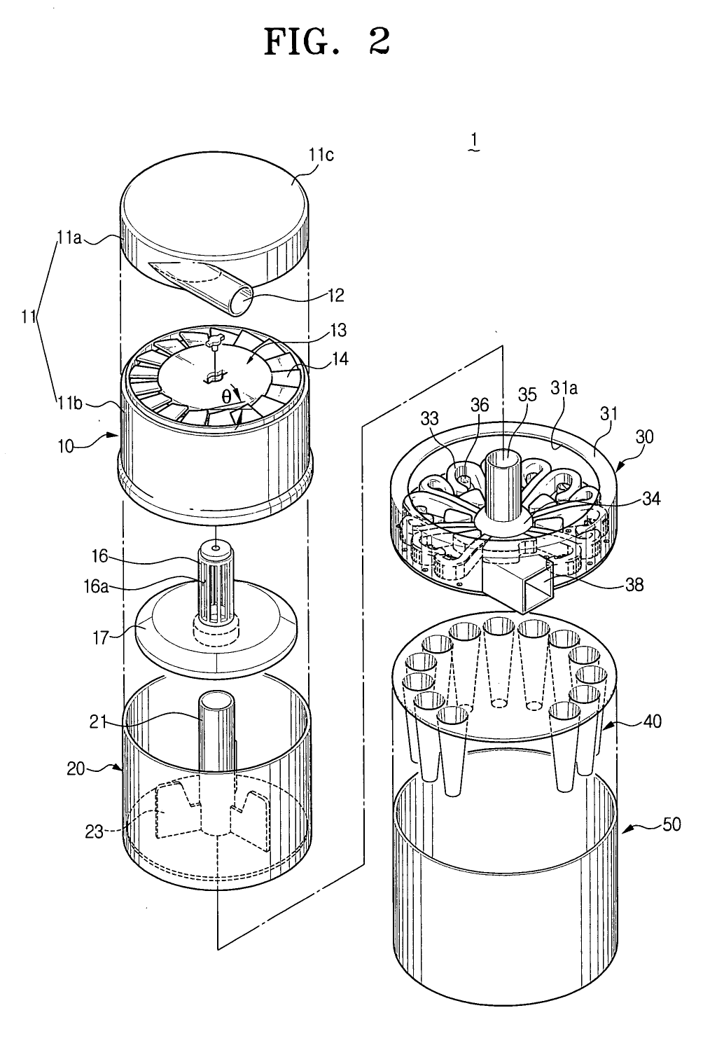

Referring to FIGS. 1 and 2, a multi-cyclone apparatus 1 according to the first embodiment of the present invention comprises a primary cyclone 10, a primary contaminant receptacle 20, a primary cover 30, a plurality of secondary cyclones 40, and a secondary contaminant receptacle 50.

The primary cyclone 10 separates large-sized contaminants from air drawn into an air inlet 12 fluidly communicated with a suction brush (not shown), and comprises a cylindrical cyclone housing II with opened bottom end, an air inlet 12, a guide vane 13, and a grille 16.

The air inlet 12 is configured in a tangential direction of the cyclone housing 11 for air drawn in a top portion of the cyclone housing 11 to flow along an inner wall of the cyclone housing 11 and form a rotative stream.

The guide vane 13 is formed under the air inlet 12 in the cyclone housing 11 and takes on the configuration of a disk with a diameter corresponding to the diameter of the cyclone housing 11. A plurality of inclined wings 14 are radially arranged by regular intervals along an outer circumference of the guide vane 13. The plurality of inclined wings 14 are inclined so that an open space is defined between each of the plurality of inclined wings 14. The length of the inclined wings 14 may be maximally the same as the radius of the guide vane 13. However, the length may be preferably set such that the flow speed, i.e., rotation speed, of rotative air drawn in via the air inlet 12 to rotate in an upper space 18 above the guide vane 13 is faster than the rotation speed of air passing the guide vane 13 to rotate in a lower space 19 below the guide vane 13. The inclination angle θ of the inclined wings 14 with respect to a top surface 11c of the cyclone housing 11 may be set such that the rotation speed of drawn-in air maximally increased. Generally, the inclination angle θ of the inclined wings 14 may be an acute angle, and may be inclined downwardly in a flowing direction of drawn-in air. The number of the inclined wings 14 may be set so as to increase the rotation speed of drawn-in air. Accordingly, air drawn in via the air inlet 12 passes between the plurality of inclined wings 14 to maximally increase the rotation speed and maximally increase the centrifugal force operating on the rotative stream. In other words, the rotation speed in the upper space 18 above the guide vane 13 is faster than the rotation speed in the lower space 19 below the guide vane 13. For convenience of explanation in FIG. 2, the cyclone housing 11 separates into an upper housing 11a and a lower housing 11b; however, this should not be considered as limiting. The cyclone housing 11 may be integrally formed.

The grille 16 is configured under the guide vane 13 and discharges air, removed of contaminant by a centrifugal force, to the secondary cyclones 40. The grille 16 is cylindrical and has an opened bottom end, and a plurality of slits 16a are formed on the outer circumference. Accordingly, air in the primary cyclone 10 discharges via the plurality of slits 16a to the secondary cyclones 40. A skirt 17 is configured at the bottom end of the grille 16 to have a smaller diameter than that of the cyclone housing 11. The skirt 17 prevents contaminants, collected in the primary contaminant receptacle 20 which will be explained later, from flowing backward into the grille 16 by a rotative stream.

The primary contaminant receptacle 20 is formed under a bottom portion of the primary cyclone 10 to collect contaminants, which are separated and falling from drawn-in air by the primary cyclone 10. The primary contaminant receptacle 20 is cylindrical and has an opened top end with a diameter corresponding to the bottom end of the cyclone housing 11 of the primary cyclone 10. An air discharge pipe 21 protrudes from a center of a bottom surface of the primary contaminant receptacle 20. The air discharge pipe 21 has opened opposite ends, of which a top end has a diameter corresponding to a bottom end of the grille 16. Accordingly, if the primary cyclone 10 is engaged with the top portion of the primary contaminant receptacle 20, the bottom end of the cyclone housing 11 is fit in the top end of the primary contaminant receptacle 20, and the bottom end of the grille 16 is fit in the top end of the air discharge pipe 21. Accordingly, air drawn in the grille 16 flows to the bottom end of the air discharge pipe 21. A plurality of counterflow prevention plates 23 are formed along the air discharge pipe 21 on the bottom surface of the primary contaminant receptacle 20.

The primary cover 30 is formed under the primary contaminant receptacle 20 to have, at a top surface 31, a receipt hole 31 a receiving the primary contaminant receptacle 20 and, at a bottom surface 32, a plurality of centrifugal air paths 33 guiding air discharged from the air discharge pipe 21 to the plurality of secondary cyclones 40. An air inlet pipe 35 is formed on a center of the bottom surface of the primary cover 30 to connect with the air discharge pipe 21 and have an opened top end. A certain cavity part 34 is formed at the bottom end of the air inlet pipe 35 to fluidly communicate with the plurality of centrifugal air paths 33 radially arranged along the air inlet pipe 35. Accordingly, air drawn in via the air inlet pipe 35 collides with the bottom surface 32 of the primary cover 30 and flows into the plurality of centrifugal air paths 33. A plurality of discharge openings 36 are formed on the bottom surface 32 of the primary cover 30 to correspond to the plurality of secondary cyclones 40, and an air outlet 38 is formed at one side of the primary cover 30. Accordingly, air flowed out of the plurality of discharge openings 36 discharges via the air outlet 38 to the motor assembly (not shown).

The plurality of secondary cyclones 40 are formed under the primary cover 30, and radially arranged to correspond to the plurality of centrifugal air paths 33. In other words, the plurality of secondary cyclones 40 are arranged in a circumference direction based on the air inlet pipe 35. The secondary cyclones 40 are conical so that atop end 42 of each of the secondary cyclones have a greater diameter than a bottom end of the secondary cyclones. The secondary cyclones 40 have at the bottom end a contaminant hole 41 to discharge contaminants. Accordingly, air passes the plurality of centrifugal air paths 33 and flows into the top end 42 of each of the plurality of secondary cyclones 40 so as to form a rotative stream in the secondary cyclones 40. The plurality of secondary cyclones 40 may be symmetrical or unsymmetrical in a circumference direction as desired.

The secondary contaminant receptacle 50 is formed under the plurality of secondary cyclones 40 to collect contaminant falling from the contaminant hole 41 of the plurality of secondary cyclones 40. At this time, the secondary contaminant receptacle 50 may be formed under the primary cover 30 to entirely cover the plurality of secondary cyclones 40. The secondary contaminant receptacle 50 can have an increased capacity with regard to fine contaminants.

The operation of the multi-cyclone apparatus 1 for a vacuum cleaner with the above structure according to the first embodiment of the present invention will be explained in detail with reference to FIGS. 1 and 2.

As the motor assembly (not shown) generates a suction force, contaminant-laden air A1 is drawn via the suction brush (not shown) through the air inlet 12 and into the primary cyclone 10. Since the air inlet 12 is formed in a tangential direction with regard to the cyclone housing 11, air passing the air inlet 12 flows along the inner wall of the cyclone housing 11 to form a rotative stream A2. Rotating in upper space 18 along the inner wall, air flows along the plurality of inclined wings 14 of the guide vane 13 to the lower space 19 below the guide vane 13. Since the plurality of inclined wings 14 of the guide vane 13 forms an acute angle with regard to the top surface 11c of the cyclone housing 11, air flowing into the lower space 19 of the guide vane 13 forms a rotative stream A3 with a higher speed than that of air A2 being in the upper space 18 of the guide vane 13. Contaminants are separated from contaminant-laden air by the centrifugal force generated by the guide vane 13 in rotative stream A3 and collected in the primary contaminant receptacle 20.

At this time, the plurality of counterflow prevention plates 23 block contaminants from flowing backward along the rotative stream of ascending air A4. Additionally, the skirt 17, formed at the bottom end of the grille 16, blocks a part of contaminants flowing backward along the rotative stream A3 to re-fall into the primary contaminant receptacle 20.

Air removed of large-sized contaminants is drawn as an air stream A5 into the plurality of slits 16a of the grille 16 and flows via the air discharge pipe 21 and the air inlet pipe 35 to collide with the bottom surface 32 of the cavity part 34 of the primary cover 30. Air collided with the bottom surface 32 of the primary cover 30 is dispersed into an air flow A6 so as to flow into the plurality of centrifugal air paths 33 radially arranged around the cavity part 34. Passing the centrifugal air paths 33, air flows A6 in the top end 42 of the secondary cyclones 40 to form a rotative stream A7 by the operation of the centrifugal air paths 33. Accordingly, fine contaminants included in air are separated by the centrifugal force to fall via the contaminant hole 41. Air A8 removed of the fine contaminants discharges via the air outlet 38 to the motor assembly (not shown).

As described above, if the multi-cyclone apparatus 1 according to the first embodiment of the present invention is applied, the rotation speed of drawn-in air A1 gets faster due to the guide vane 13 so that the centrifugal force increases and the dust collection efficiency increases for the primary cyclone 10 to separate and collect contaminant. The multi-cyclone apparatus 1 has the primary cyclone 10 and the plurality of secondary cyclones 40 arranged one on the other so that contaminants included in air are sequentially removed and fine contaminants can be collected. Therefore, dust collection efficiency can be increased. Secondary cyclones 40 can collect more contaminants as compared to conventional art devices. Since the air outlet 38 is formed at a lower portion of the multi-cyclone apparatus 1, the multi-cyclone apparatus 1 may be preferably applied to a vacuum cleaner in which the motor assembly is located under the multi-cyclone apparatus 1.

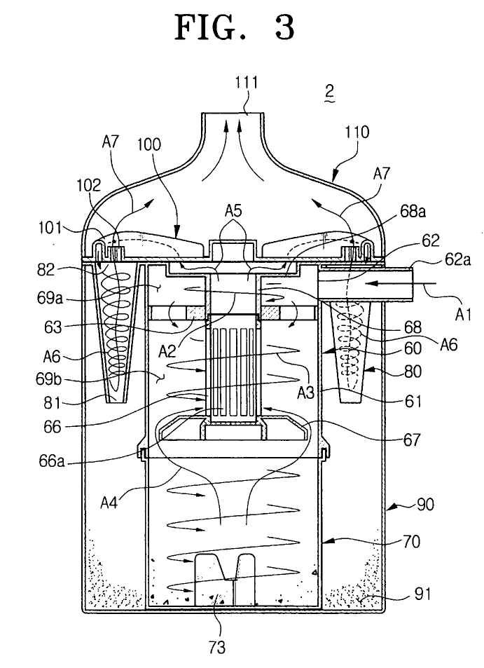

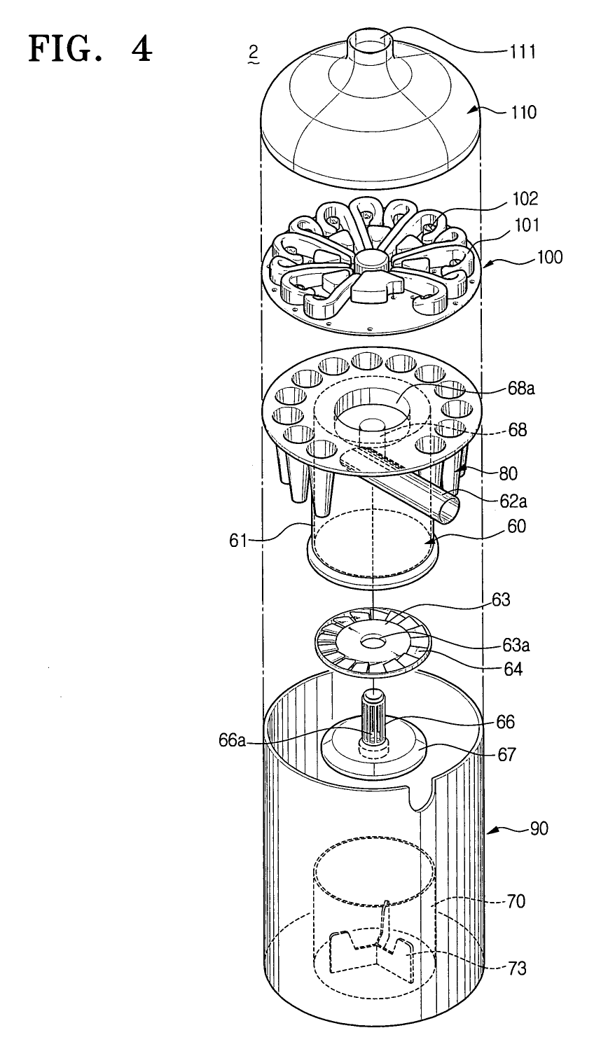

FIGS. 3 and 4 are a cross-sectional view and a perspective view, respectively, of a multi-cyclone apparatus for a vacuum cleaner according to the second embodiment of the present invention.

Referring to FIGS. 3 and 4, the multi-cyclone apparatus 2 consistent with the second embodiment of the present invention comprises a primary cyclone 60, a primary contaminant receptacle 70, a plurality of secondary cyclones 80, a secondary contaminant receptacle 90, a secondary cover 100, and a tertiary cover 110.

The primary cyclone 60 separates large-sized contaminant from air drawn in via an air inlet 62, and comprises a cyclone housing 61, the air inlet 62, a guide vane 63, and a grille 66.

The cyclone housing 61 forms a body of the primary cyclone 60 and is cylindrical, with an opened bottom end. An air discharge pipe 68 protrudes from a center on a top surface of the cyclone housing 61 to the guide vane 63. The air discharge pipe 68 is cylindrical and has opened opposite ends. A connection portion 68a is formed on a top end of the air discharge pipe 68 to fluidly communicate with a plurality of centrifugal air paths 101 of the secondary cover 100, which will be explained later. A bottom end of the air discharge pipe 68 is in fluid communication with the grille 66. Accordingly, the air discharge pipe 68 allows air drawn in the grille 66 to flow to the secondary cover 100.

The air inlet 62 is formed in a tangential direction with regard to the cyclone housing 61 to flow air drawn in a top end of the cyclone housing 61 along an inner wall of the cyclone housing 61 and form a rotative stream. An extension pipe 62a is connected with the air inlet 62 to penetrate the secondary contaminant receptacle 90 and protrude to the outside. The secondary contaminant receptacle 90 will be explained later.

The guide vane 63 is formed under the air inlet 62 in the cyclone housing 61 and takes on the configuration of a disk with a diameter corresponding to a diameter of the cyclone housing 61. A penetrating hole 63a is formed on a center of the guide vane 63 to insert the air discharge pipe 68 therein. A plurality of inclined wings 64 are radially formed in a circumferential direction of the guide vane 63 by a certain interval, and spaces between each of the plurality of inclined wings 64 are opened. The maximum length of the inclined wings 64 may be the same as the radius of the guide vane 63. However, the length may be preferably set such that the flow speed, i.e., rotation speed, of rotative air drawn in via the air inlet 62 to rotate in an upper space 69a above the guide vane 63 is faster than the rotation speed of air passing the guide vane 63 to rotate in a lower space 69b under the guide vane 63. The inclination angle θ of the inclined wings 64 with respect to a top surface of the cyclone housing 61 may be set such that the rotation speed of drawn-in air maximally increase. Generally, the inclination angle θ of the inclined wings 64 may be an acute angle, and may be inclined downwardly in a flowing direction of drawn-in air. The number of the inclined wings 64 may be set so as to increase the rotation speed of drawn-in air. Accordingly, air drawn in via the air inlet 62 passes between the plurality of inclined wings 64 to maximally increase the rotation speed and maximally increase the centrifugal force operating on the rotative stream. In other words, the rotation speed in the lower space 69b under the guide vane 63 is faster than the rotation speed in the upper space 69a above the guide vane 63.

The grille 66 is configured under the guide vane 63 and discharges air, removed of contaminant by a centrifugal force, to the secondary cyclone 80. The grille 66 is cylindrical and has an opened top end fluidly communicated with a bottom end of the air discharge pipe 68. A plurality of slits 66a are formed on the outer circumference. Accordingly, air in the primary cyclone 60 discharges via the plurality of slits 66a to the secondary cyclone 80. The bottom end of the grille 66 is closed and has a skirt 67 with a smaller diameter than that of the cyclone housing 61. The skirt 67 prevents contaminants, collected in the primary contaminant receptacle 70 which will be explained later, from flowing backward into the grille 66 by a rotative stream.

The primary contaminant receptacle 70 is formed under a bottom portion of the primary cyclone 60 to collect contaminants, which are separated and falling from drawn-in air by the primary cyclone 60. The primary contaminant receptacle 70 is cylindrical and has an opened top end with a diameter corresponding to the bottom end of the cyclone housing 61 of the primary cyclone 60. A plurality of counterflow prevention plates 73 are formed on a center of the bottom surface of the primary contaminant receptacle 70.

The plurality of secondary cyclones 80 are arranged along the primary cyclone 60, and separates fine contaminants from air drawn in via the primary cyclone 60. The secondary cyclones 80 are fluidly communicated with the primary cyclone 60 by the secondary cover 100. The secondary cyclones 80 have a conical shape so that the diameter of a top end is greater than that of a bottom end, and have, at the bottom end, a contaminant hole 81 to discharge contaminants.

The secondary cover 100 is engaged with the top end of each of the primary and the secondary cyclones 60, 80 to fluidly communicate with the primary cyclone 60 and the secondary cyclones 80. The secondary cover 100 has centrifugal air paths 101 and discharge openings 102 to correspond to the number of the secondary cyclones 80. A gasket (not shown) may be formed between the secondary cover 100 and each of the primary cyclone 60 and the secondary cyclone 80 to prevent a leakage of air. The plurality of centrifugal air paths 101 forms air, discharged via the air discharge pipe 68 of the primary cyclone 60, into a rotative stream to guide to a top inlet 82 of the secondary cyclone 80. The discharge opening 102 provides a passage through which air, removed of contaminants by the secondary cyclone 80, can discharge to the top portion of the secondary cover 100.

The tertiary cover 110 has an air outlet 111 and is configured to cover the top portion of the secondary cover 100. Accordingly, air, discharged via the plurality of discharge openings 102, discharges via the air outlet 111 to the outside of the tertiary cover 110.

The secondary contaminant receptacle 90 is configured around the primary contaminant receptacle 70 to collect contaminant separated by the plurality of secondary cyclones 80. The secondary contaminant receptacle 90 is cylindrical and has an opened top end and a closed bottom end. The diameter of the secondary contaminant receptacle 90 corresponds to the bottom end of the tertiary cover 110. Accordingly, as the secondary contaminant receptacle 90 is engaged with the bottom end of the tertiary cover 110, the secondary contaminant receptacle 90 is configured to cover the plurality of secondary cyclones 80 and the primary contaminant receptacle 70. The primary contaminant receptacle 70 and the secondary contaminant receptacle 90 may be formed by separate elements; however, they may be integrally formed by a single element. If the primary and the secondary contaminant receptacles 70, 90 are integrally formed, the primary contaminant receptacle 70 is automatically engaged with the primary cyclone 60 as the secondary contaminant receptacle 90 is connected with the bottom end of the tertiary cover 110. Contaminants separated by the plurality of secondary cyclones 80 are collected a space 91 between the primary contaminant receptacle 70 and the secondary contaminant receptacle 90.

The operation of the multi-cyclone apparatus 2 with the above structure according to the second embodiment of the present invention will be explained with reference to FIGS. 3 and 4.

As the motor assembly (not shown) generates a suction force, contaminant-laden air A1 is drawn via the air inlet 62, which is in fluid communication with the suction brush (not shown), into the primary cyclone 60. Since the air inlet 62 is formed in a tangential direction with regard to the cyclone housing 61, air passing the air inlet 62 flows along the inner wall of the cyclone housing 61 to form a rotative stream A2. Rotating along the inner wall, air flows along the plurality of inclined wings 64 of the guide vane 63 to the lower space 69b under the guide vane 63. Since each of the plurality of inclined wings 64 of the guide vane 63 forms an acute angle with regard to the top surface 61c of the cyclone housing 61, air flowed into the lower space 69b under the guide vane 63 forms a rotative stream A3 with a higher speed than that of air A2 being in the upper space 63a over the guide vane 63. Contaminants are separated from contaminant-laden air by the centrifugal force to fall into the primary contaminant receptacle 70.

At this time, the plurality of counterflow prevention plates 73 block contaminants flowing backward along the rotative stream of ascending air A4, which are formed on the bottom surface of the primary contaminant receptacle 70. The skirt 67, formed at the bottom end of the grille 66, blocks a part of contaminants flowing backward along the rotative stream to re-fall into the primary contaminant receptacle 70.

Air A5 removed of large-sized contaminant is drawn into the plurality of slits 66a of the grille 66 and flows via the air discharge pipe 68 to collide with the secondary cover 100. Air collided with the secondary cover 100 is dispersed so as to flow via the connection portion 68a into the plurality of centrifugal air paths 101 radially arranged around the air discharge pipe 68. Passing the centrifugal air paths 101, air flows in the top end 82 of the secondary cyclones 80 to form a rotative stream A6 by the operation of the centrifugal air paths 101. Accordingly, fine contaminants included in air are separated by the centrifugal force to fall via the contaminant hole 81. Air A7 removed of the fine contaminants discharges via the air outlet 102 to the top portion of the secondary cover 100. Air flowed out of the secondary cover 100 is gathered by the tertiary cover 110 to discharge via the air outlet 111 to the motor assembly (not shown).

As described above, if the multi-cyclone apparatus 2 according to the second embodiment of the present invention is applied, the rotation speed of drawn-in air gets faster due to the guide vane 63 so that the centrifugal force increases and the dust collection efficiency is enhanced for the primary cyclone 60 to separate and collect contaminants. In the multi-cyclone apparatus 2, air passing the primary cyclone 60 sequentially passes the plurality of secondary cyclones 80 so that fine contaminants can be collected. Therefore, dust collection efficiency can much increase. Since the air outlet 111 is formed at a top portion of the multi-cyclone apparatus 2, the multi-cyclone apparatus 2 may be preferably applied to a vacuum cleaner in which the motor assembly (not shown) is located over the multi-cyclone apparatus 2.

While the invention has been shown and described with reference to certain embodiments thereof, it will be understood by those skilled in the art that various changes in form and details may be made therein without departing from the spirit and scope of the invention as defined by the appended claims.

What is claimed is:

1. A multi-cyclone apparatus for a vacuum cleaner, comprising:
a primary cyclone separating a large-sized contaminant from air drawn in via an air inlet;
a guide vane formed under the air inlet in the primary cyclone to increase a speed of air drawn into the primary cyclone;
a primary contaminant receptacle collecting a contaminant separated by the primary cyclone;
a plurality of secondary cyclones fluidly communicated with the primary cyclone to separate a fine contaminant from drawn-in air; and
a secondary contaminant receptacle collecting the contaminant separated by the secondary cyclones.

2. The apparatus according to claim 1, wherein the guide vane comprises a plurality of inclined wings radially arranged by regular intervals, the plurality of inclined wings being inclined so that an open space is defined between each of the plurality of inclined wings.

3. The apparatus according to claim 1, wherein the primary contaminant receptacle is formed under the primary cyclone, the plurality of secondary cyclones are formed under the primary contaminant receptacle, and the secondary contaminant receptacle is formed under the plurality of secondary cyclones.

4. The apparatus according to claim 3, wherein the guide vane comprises a plurality of inclined wings radially arranged by regular intervals, the plurality of inclined wings being inclined so that an open space is defined between each of the plurality of inclined wings.

5. The apparatus according to claim 3, wherein the primary contaminant receptacle comprises an air discharge pipe having opened opposite ends and upwardly protruding from a center of a bottom surface to fluidly communicate with a grille of the primary cyclone.

6. The apparatus according to claim 3, further comprising:
a primary cover disposed between the primary contaminant receptacle and the plurality of secondary cyclones, the primary cover having a plurality of centrifugal air paths in fluid communication with the air discharge pipe, a plurality of discharge openings in fluid communication with the plurality of secondary cyclones, and an air outlet discharging air flowing out of the plurality of discharge openings.

7. The apparatus according to claim 6, wherein the primary cover further comprises an air inlet pipe having a top end connected with the air discharge pipe and a bottom end connected with the plurality of centrifugal air paths, the plurality of centrifugal air paths being radially arranged.

8. The apparatus according to claim 1, wherein the primary contaminant receptacle is formed under the primary cyclone, the plurality of secondary cyclones are formed around the primary cyclone, and the secondary contaminant receptacle is formed around the primary contaminant receptacle.

9. The apparatus according to claim 8, wherein the guide vane comprises a plurality of inclined wings radially arranged by regular intervals, the plurality of inclined wings being inclined so that an open space is defined between each of the plurality of inclined wings.

10. The apparatus according to claim 8, further comprising:
a secondary cover formed over the primary cyclone and the plurality of secondary cyclones, the secondary cover having the plurality of centrifugal air paths guiding air, discharged from the primary cyclone, to the plurality of secondary cyclones.

11. The apparatus according to claim 10, further comprising:
a tertiary cover formed over the secondary cover, the tertiary cover having an air outlet discharging air that passes the plurality of secondary cyclones.

12. The apparatus according to claim 8, wherein the air inlet is connected with an extension pipe extended to the outside of the secondary contaminant receptacles.

13. The apparatus according to claim 8, wherein the primary contaminant receptacle and the secondary contaminant receptacle are integrally formed.

14. A multi-cyclone apparatus for a vacuum cleaner, comprising:
a primary cyclone having an air inlet for drawn-in air and forming a first rotative stream in the drawn-in air;
a guide vane under the air inlet to increase a speed of the first rotative stream; and
a plurality of secondary cyclones fluidly communicated with the primary cyclone, said plurality of secondary cyclones each forming a second rotative stream in the drawn-in air.

15. The apparatus according to claim 14, wherein the guide vane comprises a plurality of inclined wings radially arranged by regular intervals, the plurality of inclined wings being inclined so that an open space is defined between each of the plurality of inclined wings.

16. The apparatus according to claim 14, further comprising:
a primary contaminant receptacle collecting a contaminant separated by the primary cyclone; and
a secondary contaminant receptacle collecting the contaminant separated by the secondary cyclones.

17. The apparatus according to claim 16, wherein the primary contaminant receptacle is formed under the primary cyclone, the plurality of secondary cyclones are formed under the primary contaminant receptacle, and the secondary contaminant receptacle is formed under the plurality of secondary cyclones.

18. The apparatus according to claim 16, wherein the primary contaminant receptacle is formed under the primary cyclone, the plurality of secondary cyclones are formed around the primary cyclone, and the secondary contaminant receptacle is formed around the primary contaminant receptacle.
